(19) United States
(12) Patent Application Publication
(10) Pub. No.: US 2024/0248452 A1
(43) Pub. Date: Jul. 25, 2024

(54) METHOD AND MONITORING DEVICE FOR MONITORING THE CONDITION OF A MACHINE

(71) Applicant: Innomotics GmbH, Nürnberg (DE)

(72) Inventors: Jens Winter, Hessisch Lichtenau (DE); Sascha Dumke, Nürnberg (DE); Veronika Liebig, Aichach (DE); Mohamed Khalil, München (DE); Birgit Obst, München (DE)

(21) Appl. No.: 18/576,435

(22) PCT Filed: Jun. 23, 2022
(86) PCT No.: PCT/EP2022/067128

§ 371 Date: Jan. 4, 2024

(30) Foreign Application Priority Data
Jul. 14, 2021 (EP) 21185596.0

(51) Int. Cl. G05B 19/4065; G01M 99/00

(52) U.S. Cl. CPC G05B 19/4065; G01M 99/005; G05B 2219/50185

(57) ABSTRACT

In order to monitor the condition of a machine, current operating data relating to the machine are continuously captured and are taken as a basis for continuously simulating a current operating behavior of a machine component by a concurrent simulation module. Furthermore, performance values quantifying a current performance of the machine component are continuously derived from the simulated operating behavior and are stored over time. In addition, a performance normal value is regularly determined on the basis of a multiplicity of performance values which were derived earlier. The operating data and/or the performance values are monitored in order to determine whether a predefined first change pattern occurs. Detection of the first change pattern then causes a performance reference value to be updated with the current performance normal value. In addition, the respective current performance values are continuously compared with the current performance reference value in each case.

### CROSS-REFERENCE TO RELATED APPLICATIONS

This application claims priority to PCT Application No. PCT/EP2022/067128, having a filing date of Jun. 23, 2021, which claims priority to EP Application No. 21185596.0, having a filing date of Jul. 14, 2021, the entire contents both of which are hereby incorporated by reference.

### FIELD OF TECHNOLOGY

The following relates to a method and monitoring device for monitoring the condition of a machine.

### BACKGROUND

In the operation of complex machines, efforts are increasingly being made to replace hitherto conventional reactive or preventive maintenance with dynamic maintenance oriented toward the actual state of health of the machine. In preventive maintenance, the machine is shut down, checked and serviced at regular time intervals. In the process, however, still intact component parts are often exchanged, the remaining lifetime of which has not yet been exhausted. In reactive maintenance, the machine is shut down, repaired and serviced, if appropriate, when a malfunction occurs. However, an unexpected malfunction and attendant outage times may lead to problems, particularly if the malfunction occurs in a critical operating phase.

By contrast, modern monitoring devices, so-called “condition monitoring” systems, permit state-oriented maintenance strategies, in which a lifetime of critical machine components can be better utilized, and maintenance measures can be coordinated more flexibly with operating requirements of the machine. In particular, monitoring devices of this type can measure loadings of machine components or component parts and/or count load cycles. On the basis of known damage accumulation models, remaining lifetimes of machine components or component parts can then be statistically estimated, from which optimized servicing cycles can then in turn be derived.

In this case, a fundamental problem consists in measuring or determining indicators which are meaningful for a loading or a state of health of the machine. Precisely in complex machines, however, critical machine components are in many cases difficult to access for measurements. In this regard, installing sensors on an often highly loaded rotor of a motor and transporting sensor signals from there to a monitoring device generally involves very great technical complexity and expenditure.

It is known, for the purpose of monitoring the state of a machine, to evaluate measurement values from sensors fitted at more easily accessible locations of the machine to be monitored. On the basis of these measurement values, the loading of less accessible machine components can then be deduced in many cases with the aid of physical simulation models.

Furthermore, there is the problem that measured loadings often affect a state of health of the machine in very different ways. In particular, these effects may vary greatly depending on installation location, configuration, modifications, services carried out and/or ambient conditions of the machine.

### SUMMARY

An aspect relates to a method and a monitoring device for monitoring the state of a machine which enables a state of health of the machine to be better determined.

For the purpose of monitoring the state of a machine, in particular a motor, a robot, a machine tool, a manufacturing apparatus, a turbine, a 3D printer, an internal combustion engine and/or a motor vehicle, current operating data of the machine are continuously captured. On the basis of the operating data, a current operating behavior of a machine component is continuously simulated by a concurrent simulation module. Furthermore, performance values quantifying a current performance of the machine component are continuously derived from the simulated operating behavior and stored over the course of time. Moreover, a performance normal value is regularly determined on the basis of a multiplicity of performance values derived earlier. Furthermore, the operating data and/or the performance values are monitored to establish whether a predefined first change pattern occurs. An update of a performance reference value with the current performance normal value is then instigated on account of a detection of the first change pattern. Moreover, the respective current performance values are continuously compared with the respective current performance reference value. A current state of health of the machine component is then displayed depending on the comparison result.

For the purpose of carrying out the method according to embodiments of the invention, provision is made of a monitoring device, a computer program product (non-transitory computer readable storage medium having instructions, which when executed by a processor, perform actions) and a computer-readable, nonvolatile, storage medium.

In embodiments, the method according to the invention and the monitoring device according to embodiments of the invention can be carried out and implemented for example by one or more computers, processors, application-specific integrated circuits (ASIC), digital signal processors (DSP) and/or so-called “field programmable gate arrays” (FPGA).

One advantage of embodiments of the invention can be seen in particular in that performance reference values can be dynamically and automatically adapted to changes in operating conditions of the machine. In this way, operationally dictated performance variations, for example owing to servicing of individual component parts, an altered configuration or altered ambient conditions, which often do not significantly influence a state of health, can be taken into account in the evaluation of the state of health.

In accordance with an embodiment of the invention, the first change pattern can specify a threshold value for a fluctuation amplitude, for a temporal gradient and/or for a temporal variance of the performance values and/or of the operating data. Alternatively, or additionally, the first change pattern can specify a distance between a performance value and the current performance reference value and/or a time period in which a fluctuation amplitude of the performance values and/or of the operating data lies below a threshold value. Operating phases in which there is only little change in a performance, and which are therefore suitable as reference operating phase can be detected in a targeted manner by such a first change pattern. Consequently, an update of the performance reference value can be instigated when such a reference operating phase is detected.

According to an embodiment of the invention, current surroundings data of the machine can be continuously captured. The comparison between the current performance values and the current performance reference value can then be effected depending on the current surroundings data. In particular, an ambient temperature, air humidity, an installation location, a time of day, a day of the week, a calendar date and/or a season can be captured as surroundings data. In this way, influences of surroundings on the performance can be taken into account in the evaluation of the state of health.

Furthermore, the surroundings data can be monitored to establish whether a predefined second change pattern occurs. An update of the performance reference value with the current performance normal value can then be instigated on account of a detection of the second change pattern. Second change patterns of this type can specify in particular threshold values, fluctuation amplitude, gradients, variances and/or time periods in the temporal profile of the surroundings data. Operating phases in which there is only little change in one or more ambient conditions of the machine, and which are therefore suitable as reference operating phase can be detected in a targeted manner by such a second change pattern. Consequently, an update of the performance reference value can be instigated when such a reference operating phase is detected.

Analogously thereto, the machine can be monitored to establish whether a machine component and/or a component part of the machine is exchanged or altered. An update of the performance reference value with the current performance normal value can then be instigated, if appropriate with a predefined or calculated time delay, on account of a detection of such an exchange and/or such an alteration. In this way, an alteration of the machine can be taken into account in the evaluation of the state of health.

According to an embodiment of the invention, for the purpose of ascertaining the performance normal value an operating phase can be detected in which a fluctuation amplitude of the performance values is below average and/or lies below a predefined threshold value. Additionally, or alternatively, for the purpose of ascertaining the performance normal value a moving average of the performance values can be determined. In particular, the performance normal value can be set to a current moving average of the performance values when an operating phase with small fluctuations of the performance values is detected. As already mentioned above, such an operating phase is often suitable as reference operating phase.

According to an embodiment of the invention, a future state of health of the machine component can be continuously predicted by a concurrent prediction module on the basis of the simulated operating behavior. In particular, a point in time of a probable occurrence of damage, a probable remaining lifetime of the machine component and/or a temporal development of fatigue phenomena can be predicted.

A loading of the machine component can be continuously determined by the prediction module on the basis of the simulated operating behavior. The future state of health can then be predicted from the loading by a dynamic loading model, wear model, degradation model or lifetime model. For predictions of this type, a large number of known dynamic models and efficient numerical methods for the evaluation thereof are available. In particular, a combination of an extrapolation of historical states of health and one or more physical degradation models can be used. The latter apply loadings such as stresses, vibrations or high temperatures dynamically to structural mechanics and/or the material properties thereof. Moreover, empirical remaining lifetime curves can also be taken into account in the prediction.

A prediction uncertainty, a confidence interval and/or a probability of damage can be determined by the dynamic loading model, wear model or lifetime model. In this case, a prediction uncertainty can be composed of an inaccuracy of the prediction model(s) used, an inaccuracy in the capture of the operating data, and an uncertainty of constraints. In this way, a meaningfulness of a predicted state of health can generally be assessed considerably better.

According to an embodiment of the invention, in the context of the comparison between a performance value and the performance reference value, a distance between the performance value and the performance reference value, a temporal gradient of the distance and/or a temporal variance of the distance can be determined. The current state of health can then be displayed depending on the distance, the gradient and/or the variance. In this regard, in particular in phases with comparatively high variance of the distance, a current distance and/or a current gradient of the distance can be given smaller weighting in the evaluation of the state of health. In this way, it is often possible to prevent momentary fluctuations of the distance from adversely affecting the display of the state of health by virtue of artefacts.

In accordance with an embodiment of the invention, a plurality of machine components can be monitored, wherein for each of the machine components
the simulation module can have a component-specific simulation model for simulating the respective machine component,
the prediction module can have a component-specific prediction model for predicting a future state of health of the respective machine component,
component-specific performance values can be derived,
a component-specific performance normal value can be determined by a component-specific calculation method,
a component-specific performance reference value can be used,
component-specific change patterns can be predefined,
a component-specific comparison can be carried out, and/or
a component-specific state of health can be displayed.

In this case, it is possible to implement in particular component-specific processing pipelines each with a component-specific simulation model, a component-specific performance value determination, a component-specific reference value determination, a component-specific performance value comparison and/or a component-specific prediction model. Processing pipelines of this type can be executed in parallel and can particularly easily be extended by new processing pipelines for additional machine components.

According to an embodiment of the invention, by combining the component-specific states of health, an overall state of health of the machine can be derived and displayed. The combination can be effected by logic operators.

### BRIEF DESCRIPTION

Some of the embodiments will be described in detail, with references to the following Figures, wherein like designations denote like members, wherein:

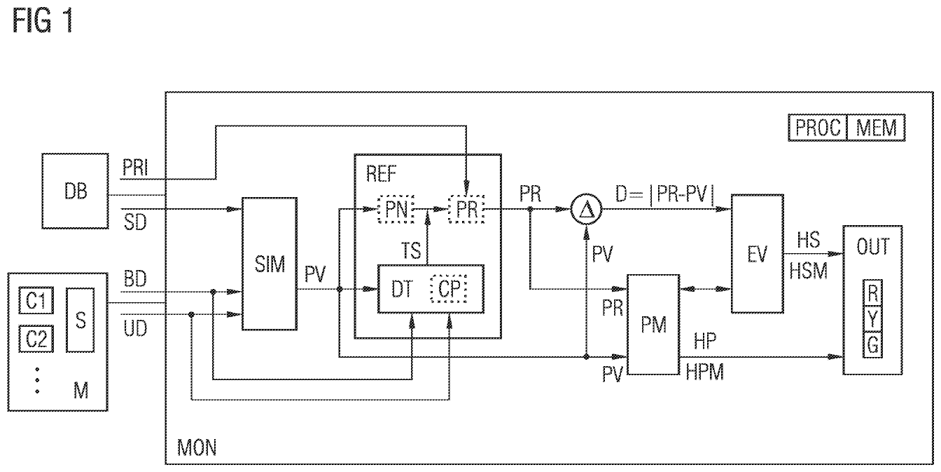

FIG. 1 illustrates monitoring of a machine by a monitoring device according to embodiments of the invention;

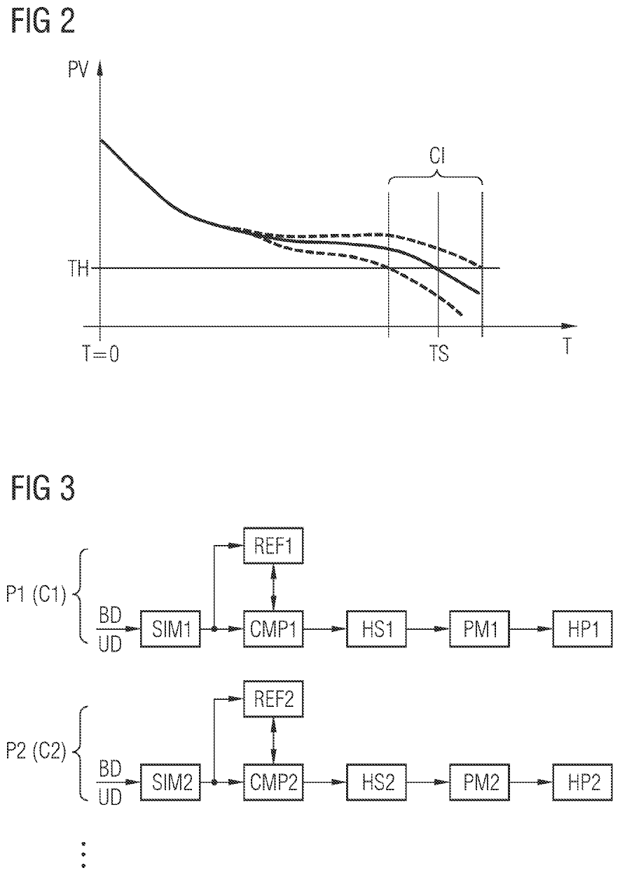

FIG. 2 illustrates a predicted profile of a performance value; and

FIG. 3 illustrates a plurality of component-specific processing pipelines of a monitoring device according to embodiments of the invention.

### DETAILED DESCRIPTION

FIG. 1 illustrates monitoring of a machine M by a monitoring device MON according to embodiments of the invention, which is coupled to the machine M. The machine M can be in particular a robot, a machine tool, a manufacturing apparatus, a turbine, a 3D printer, an internal combustion engine and/or a motor vehicle or can comprise such a machine. The machine M has a plurality of machine components C1, C2, . . . , which are to be monitored component-specifically. For reasons of clarity, only two machine components C1 and C2 are explicitly illustrated in the drawing. If the machine M is an electric motor, a respective machine component C1 or C2 can be for example a rotor, an axle bearing, a cooling facility, a stator, a winding or an insulation.

The monitoring device MON is shown external to the machine M in the illustration in FIG. 1. As an alternative thereto, the monitoring device MON can also be wholly or partly integrated into the machine M.

The monitoring device MON has one or more processors PROC for carrying out method steps of embodiments of the invention, and one or more memories MEM for storing data to be processed. Monitoring devices MON of this type are often also referred to as “condition monitoring” systems.

The machine M has a sensor system S for continuously measuring and/or capturing operating data BD of the machine M and surroundings data UD from surroundings of the machine M. Operating data BD and/or surroundings data UD can be captured in a different way aside from by the sensor system S.

In particular, current operating signals, sensor data and/or measurement values which quantify a power, a rotational speed, a torque, a speed of movement, a force exerted, a pollutant emission and/or a temperature of one or more machine components over the course of time can be captured as operating data BD. Analogously thereto, the surroundings data UD can indicate e.g., an ambient temperature or an air humidity in surroundings of the machine M over the course of time. Furthermore, the surroundings data UD can specify an installation location and/or an installation manner of the machine M, a time of day, a calendar date and/or a season. The operating data BD and the surroundings data UD are continuously captured and communicated to the monitoring device MON or captured by the latter.

According to embodiments of the invention, the monitoring device MON has a concurrent simulation module SIM for the real-time simulation of a current operating behavior of the machine M and/or the components thereof, here C1 and C2, in parallel with the ongoing operation of the machine M. In particular, the simulation module SIM continuously simulates loadings of the machine components C1 and C2. For the purpose of the simulation, the operating data BD and the surroundings data UD are continuously fed into the simulation module SIM.

In the present exemplary embodiment, the simulation module SIM has a plurality of component-specific simulation models (not illustrated) for the respective component-specific simulation of the machine component C1 or C2. In this case, a respective component-specific simulation model can comprise a plurality of domain-specific submodels, e.g., a mechanical submodel, an electrical submodel and/or a thermal submodel. A large number of efficient domain-specific simulation models are available for mechanical, electrical or thermal simulations of this type. Typical implementations of simulation modules of this type may indeed comprise 30 or 40 submodels.

The simulation module SIM or its simulation models are initialized by structural data SD of the machine M from a database DB coupled to the monitoring device MON. The structural data SD specifies in particular a geometry, physical properties and other operating parameters of machine elements of the machine M and, in particular, of the machine components C1 and C2. On the basis of the structural data SD, the simulations by the operating data BD and the surroundings data UD can be performed by way of known simulation methods. Either detailed physical simulation models such as e.g., so-called finite element models or else efficient data-driven surrogate models are available for this purpose. A surrogate model used can be, in particular, a neural network or some other machine learning model which, by a precise physical simulation model, has been trained beforehand to reproduce the simulation results of the model as accurately as possible. An evaluation of surrogate models of this type generally requires considerably less extensive computation resources than a detailed physical simulation model.

From the respective simulated current operating behavior of the machine components C1 and C2, a respective performance value PV is continuously derived, which quantifies a respective current performance of the relevant machine component C1 or C2. In this case, the performance of a respective machine component C1 or C2 can concern in particular a rotational speed, a power, a resource requirement, a yield, an efficiency, a precision, a pollutant emission, a stability, vibrations, wear, a loading and/or other target parameters of the machine M and/or the components thereof, here C1 and C2. In particular, as performance values PV, indicators for a loading of the machine components C1 and C2 are determined, such as e.g., stresses, vibrations, high forces, high temperatures or high pressures. The simulation thus realizes as it were virtual sensors for the performance of the machine components C1 and C2.

The component-specific performance values PV are stored as time series.

The simulation module SIM communicates the performance values PV to a reference value module REF of the monitoring device MON. The reference value module REF serves for dynamically determining and adapting component-specific reference values PR for the performance values PV. In order to determine a respective component-specific reference value PR, a component-specific performance normal value PN is regularly derived on the basis of the communicated performance values PV. The performance normal value PN is intended to serve as a comparison measure for a respective performance in a normal state or target state of the machine M. For this purpose, a moving average, e.g., over a number of hours, days or weeks, or some other mean value of the performance values PV in operating phases with small temporal fluctuations is formed and stored as performance normal value PN.

The performance reference value PR for a respective machine component C1 or C2 is dynamically updated on the basis of the regularly derived performance normal values PN.

At the beginning of the operation of the machine M or at other initialization times, the performance reference value PR is initialized by way of an initial component-specific performance value PRI retrieved e.g., from the database DB. Since the operating conditions may change depending on installation location, installation manner, ambient influences, servicing work or reconfigurations, the performance reference value is dynamically updated according to embodiments of the invention when predefined change patterns occur and/or when an exchange or an alteration of machine elements is recognized.

For detecting change patterns and for detecting an exchange or an alteration of machine elements, the reference value module REF has a detector DT. The detector DT monitors in particular the performance values PV and optionally the operating data BD to establish whether a predefined first change pattern occurs. Furthermore, the detector DT monitors the surroundings data UD to establish whether a predefined second change pattern occurs. For this purpose, the surroundings data UD and optionally the operating data BD are communicated to the reference value module REF and fed into the detector DT. The first and second change patterns are denoted in a conflated manner by the reference sign CP in FIG. 1. Both change patterns CP are each predefined in a component-specific manner, i.e., in a manner specific to each of the components C1 and C2.

The first change pattern specifies in particular those changes in the operating data BD and/or performance values PV which are intended to trigger an update of the performance reference value PR. For this purpose, the first change pattern can specify for example a threshold value for a fluctuation amplitude, a temporal gradient and/or a temporal variance of the operating data BD and/or of the performance values PV. In this way, an update of the performance reference value PR can be triggered when a fluctuation amplitude, a gradient and/or a variance of the performance values PV and/or of the operating data BD remain(s) comparatively small over a predefined period of time and thus indicate(s) a normal operating phase suitable as reference. Accordingly, a time period with a small fluctuation amplitude can also be specified by the first change pattern. Alternatively, or additionally, the first change pattern can predefine a distance between a performance value PV and the performance reference value PR which triggers an update in the event of its being exceeded or undershot.

The second change pattern defines in a component-specific manner what changes in the surroundings data UD are intended to trigger an update of the performance reference value PR. For this purpose, analogously to the first change pattern, the second change pattern can specify a threshold value for a fluctuation amplitude, a temporal gradient and/or a temporal variance of the surroundings data UD in order thus to define a normal operating phase suitable as reference.

As soon as the detector DT detects an occurrence of the change patterns CP or a change or an exchange of a machine element on the basis of the operating data BD, the surroundings data UD and the performance values PV, the detector DT forms a component-specific trigger signal TS. For a respective machine component C1 or C2, an update of the performance reference value PR for the respective machine components C1 or C2 with the performance normal value PN of the respective machine component C1 or C2 is triggered by the component-specific trigger signal TS. The trigger signal TS can be formed in particular when all normal state indicators coincide. Moreover, an update can also be instigated at predefined points in time, e.g., at night or at the weekend.

The component-specific performance reference value PR serves as current reference for an evaluation of a current state of health of a respective machine component C1 or C2. For this purpose, the current performance values PV are continuously compared with the current performance reference value PR in a component-specific manner. A current component-specific distance D between a current performance value PV and the performance reference value PR is formed in this case. By way of example, an absolute value or a square of a difference PV−PR or a relative distance D=|PV−PR|/PR can be determined as distance D.

The distance D determined is fed as comparison result into an evaluation module EV of the monitoring device MON. The evaluation module EV evaluates a current state of health of a respective machine component C1 or C2 in a component-specific manner on the basis of the component-specific distances D, also on the basis of the temporal profiles thereof. For this purpose, it is possible to compare distances D at different, in particular successive, points in time. In this regard, a temporal gradient of successive distances can be formed in order for example to detect increases in the distances D and to evaluate them as a deterioration in a state of health. Moreover, a temporal variance of the distances D can also be determined in order thus to distinguish normal fluctuations of the distance D from unusual fluctuations indicating a deterioration in a state of health. Moreover, the evaluation device EV can compare the distances D with predefined or calculated threshold values that define critical states of health. Moreover, the evaluation module EV can also compare the performance values PV directly with a predefined performance threshold value, the exceeding or undershooting of which should be assessed as damage, e.g., if a power of a machine component undershoots a mandatorily prescribed minimum power.

Depending on the distances D, the evaluation module EV determines for each component C1 and C2 a current component-specific health indication HS specifying the state of health of the relevant component C1 or C2. In the present exemplary embodiment, the evaluation device EV checks in a component-specific manner whether a respective distance D and/or the temporal gradient thereof, optionally taking into account a temporal variance, exceed(s) a first component-specific threshold value and a second component-specific threshold value. In this case, the first threshold value defines, in a component-specific manner, a maximum deviation from a target behavior which is regarded as non-critical. By contrast, the second threshold value defines, in a component-specific manner, a deviation from the target behavior which, when exceeded, necessitates an immediate or prompt user action. The current health indication HS indicates in particular whether the first threshold value and the second threshold value are exceeded. Moreover, the current health indication HS can also specify the current distance D from the target behavior, specific damage, a failure and/or a probability of an occurrence of damage, a malfunction or a failure.

From the current health indications HS for the individual components C1 and C2, the evaluation module EV also derives a current overall health indication HSM specifying a current overall state of health of the machine M. For this purpose, individual current health indications HS can be combined for example by logic operators to form the current overall health indication HSM. In this regard, a critical overall state of the machine M can be indicated as soon as a critical state of health is determined for one of the machine components C1 or C2.

The current health indications HS for the components C1 and C2 and the current overall health indication HSM are communicated to an output unit OUT of the monitoring device MON by the evaluation module EV. The output unit OUT can comprise a display, an alarm device, an online notification system or some other form of signaling or message issuing. The output unit OUT can output a monitoring signal, an alarm signal, an operational recommendation, a false signal, a diagnostic signal and/or a servicing signal.

In the present exemplary embodiment, the output unit OUT comprises respective traffic light displays for displaying the component-specific health indications HS and the overall health indication HSM. The traffic light displays respectively comprise a green display G, a yellow display Y and a red display R. The green display G is driven in each case if the relevant distance D lies below the first threshold value. The state of health of the relevant component is non-critical in this case. Accordingly, the red display R is driven in each case if the relevant distance D lies above the second threshold value, which indicates a critical state of health of the relevant component and necessitates an immediate or prompt user action. Accordingly, the yellow display Y is driven in each case if the relevant distance D lies between the first and second threshold values. An observation of the corresponding machine component can be recommended in this way.

The current overall health indication HSM can be displayed analogously by a traffic light display provided for this.

The monitoring device MON furthermore has a concurrent prediction module PM having a plurality of component-specific prediction models. The performance values PV and the performance reference value PR are fed into the prediction module PM. In an embodiment, the current health indications HS and optionally the respective current overall health indication HSM are also communicated to the prediction module PM by the evaluation module EV. The prediction module PM serves the purpose of continuously predicting a future state of health of a respective machine component C1 or C2 on the basis of the operating behavior simulated by the simulation module SIM during ongoing operation of the machine M. The prediction models can comprise in particular a dynamic loading model, a dynamic wear model, a dynamic degradation model or a dynamic lifetime model. A large number of methods are available for application and for numerical evaluation of prediction models of this type.

The prediction module PM continuously determines a loading of the machine components C1 and C2 on the basis of the performance values PV. From the respective loading, the prediction module PM then predicts, by its prediction models, a future development of the performance of the machine components C1 and C2 or a temporal development of fatigue phenomena of the machine components C1 and C2. In particular, a remaining lifetime of the machine components C1 and C2 and/or a time period until damage occurs can thus be predicted. If appropriate, it is also possible for no temporal development of the performance reference value PR to be predicted.

In order to determine a future state of health, predicted performance values PV can be compared with a current or predicted performance reference value PR, and a distance between the predicted performance values PV and the current or predicted performance reference value PR can be determined in each case. A future state of health for a respective machine component C1 and C2 can then be derived from this distance, as described above.

The prediction module PM thus generates for a respective machine component C1 or C2 an indication HP about a future state of health of this machine component. Furthermore, the prediction module PM generates an indication HPM about a future overall state of health of the machine M and communicates it together with the component-specific indications HP to the output unit OUT, where the predicted indications HP and HPM can be displayed by traffic light displays analogously to the current indications HS and HSM. In this case, as described above in connection with the current health indications HS and HSM, the indication HPM can be ascertained by combining the component-specific indications HP.

The indications HP and HPM can be determined for one or more time intervals in the future.

In addition to the predictions about future states of health, the prediction module PM also determines a prediction uncertainty, a confidence interval and/or a probability of damage. When determining the above variables, it is possible to take into account, in particular, an uncertainty of physical constraints or measurement inaccuracies and an intrinsic inaccuracy of the simulation models.

FIG. 2 illustrates a profile of a performance value PV predicted by the prediction module PM. The predicted profile here is plotted against time T. In this case, the point in time T=0 denotes a respective current time, while future points in time are plotted to the right thereof.

While the predicted profile of the performance values PV is illustrated by a solid line, an uncertainty of the temporal prediction is indicated by dashed lines. Furthermore, a performance threshold value TH is plotted, the undershooting of which by the performance value PV should be assessed as damage. The predicted profile of the performance value PV undershoots the performance threshold value TH at the point in time TS, which can thus be ascertained as a probable point in time of occurrence of damage. On the basis of the profile of the prediction uncertainty, it is furthermore possible to determine a confidence interval CI in which the damage occurs with extremely high probability or with predefined probability. In this case, the confidence interval CI can be determined from the points of intersection of the dashed profiles with the performance threshold value TH.

A respective component-specific confidence interval CI can be displayed together with the indications HP about a future state of health of a respective component.

FIG. 3 shows a plurality of component-specific processing pipelines P1 and P2 of a monitoring device according to embodiments of the invention. The processing pipeline P1 serves for monitoring a state of health of the machine component C1, while the processing pipeline P2 serves for monitoring a state of health of the machine component C2. Optionally, component-specific operating data BD and surroundings data UD are fed into both processing pipelines P1 and P2.

The processing pipeline P1 comprises a simulation module SIM1 for the concurrent simulation of a current operating behavior of the machine component C1. Furthermore, a reference value determination REF1 specific to the machine component C1 is provided. Moreover, the processing pipeline P1 carries out a comparison CMP1—specific to the machine component C1—of the performance values specific to this component C1 with the performance reference value specific to this component C1. The reference value determination REF1 and in particular the update of the relevant performance reference value is carried out in a component-specific manner, as described above. A current state of health HS 1 specific to the machine component C1 is determined depending on the component-specific comparison result. Furthermore, a prediction model P1 specific to the machine component C1 predicts a future state of health HP1 specific to this component C1.

The processing pipeline P2 specific to the machine component C2 operates in an analogous manner.

The processing pipelines P1 and P2 are executed in parallel and in real time during ongoing operation of the machine M. On account of the separation of the processing pipelines, here P1 and P2, for the individual components, here C1 and C2, the monitoring device MON can be extended by monitoring of further machine components in a particularly simple manner.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for monitoring the state of a machine, wherein
a) continuously capturing current operating data of the machine;
b) continuously simulating by a concurrent simulation module, on the basis of the operating data, a current operating behavior of a machine component;
c) continuously deriving performance values quantifying a current performance of the machine component from the simulated operating behavior and stored over the course of time;
d) regularly determining a performance normal value on the basis of a multiplicity of performance values derived earlier;
e) monitoring the operating data and/or the performance values to establish whether a predefined first change pattern occurs;
f) instigating an update of a performance reference value with the current performance normal value (PN) on account of a detection of the first change pattern;
g) continuously comparing the respective current performance values with the respective current performance reference value; and
h) displaying a current state of health of the machine component depending on the comparison result.

2. The method as claimed in claim 1,
wherein the first change pattern
specifies a threshold value for a fluctuation amplitude, for a temporal gradient and/or for a temporal variance of the performance values and/or of the operating data,
specifies a distance between a performance value and the current performance reference value and/or
specifies a time period in which a fluctuation amplitude of the performance values and/or of the operating data lies below a threshold value.

3. The method as claimed in claim 1, wherein current surroundings data of the machine are continuously captured, and
in that the comparison between the current performance values and the current performance reference value is effected depending on the current surroundings data.

4. The method as claimed in claim 1, wherein current surroundings data of the machine are continuously captured,
in that the surroundings data are monitored to establish whether a predefined second change pattern occurs, and
in that an update of the performance reference value with the current performance normal value is instigated on account of a detection of the second change pattern.

5. The method as claimed in claim 1, wherein the machine is monitored to establish whether a machine component and/or a component part of the machine is exchanged or altered, and in that an update of the performance reference value with the current performance normal value is instigated on account of a detection of such an exchange and/or such an alteration.

6. The method as claimed in claim 1, wherein for ascertaining the performance normal value
an operating phase is detected in which a fluctuation amplitude of the performance values is below average and/or lies below a predefined threshold value, and/or
a moving average of the performance values is determined.

7. The method as claimed in claim 1, wherein a future state of health of the machine component is continuously predicted by a concurrent prediction module on the basis of the simulated operating behavior.

8. The method as claimed in claim 7,
wherein the prediction module
continuously determines a loading of the machine component on the basis of the simulated operating behavior, and
predicts the future state of health from the loading by a dynamic loading model, wear model or lifetime model.

9. The method as claimed in claim 8,
wherein a prediction uncertainty, a confidence interval and/or a probability of damage are/is determined by the dynamic loading model, wear model or lifetime model.

10. The method as claimed in claim 1 wherein in the context of the comparison between a performance value and the performance reference value, a distance between the performance value and the performance reference value, a temporal gradient of the distance and/or a temporal variance of the distance are/is determined, and
in that the current state of health is displayed depending on the distance, the gradient and/or the variance.

11. The method as claimed in claim 1, wherein a plurality of machine components are monitored, wherein for each of the machine components
the simulation module has a component-specific simulation model for simulating the respective machine component;
component-specific performance values are derived;
a component-specific performance normal value is determined by a component-specific calculation method;
a component-specific performance reference value is used;
component-specific change patterns are predefined;
a component-specific comparison is carried out; and/or
a component-specific state of health is displayed.

12. The method as claimed in claim 11,
wherein by combining the component-specific states of health, an overall state of health of the machine is derived and displayed.

13. A monitoring device for monitoring the state of a machine, configured for carrying out a method as claimed in claim 1.

14. A computer program product, comprising a computer readable hardware storage device having computer readable program code stored therein, said program code executable by a processor of a computer system to implement a method configured for carrying out a method as claimed in claim 1.

15. A computer-readable storage medium comprising a computer program product as claimed in claim 14.
